(19) United States
(12) Patent Application Publication
(10) Pub. No.: US 2026/0330259 A1
(43) Pub. Date: Oct. 22, 2026

(54) METHOD AND APPARATUS FOR GENERATING PERSONALIZED RESPONSE

(71) Applicant: SAMSUNG SDS CO., LTD., Seoul (KR)

(72) Inventors: Jin Woong PARK, Seoul (KR); Hyun Woo CHOO, Seoul (KR); Jee Eun SUK, Seoul (KR); Sung Eun KIM, Seoul (KR); Seung Jin KIM, Seoul (KR); Ki Chul JUNG, Seoul (KR)

(73) Assignee: SAMSUNG SDS CO., LTD., Seoul (KR)

(21) Appl. No.: 19/335,659

(22) Filed: Sep. 22, 2025

(30) Foreign Application Priority Data
Apr. 21, 2025 (KR) 10-2025-0051433

(51) Int. Cl. G06N 5/04

(52) U.S. Cl. CPC G06N 5/04

(57) ABSTRACT

A method for generating a personalized response may include obtaining a question from a terminal of a first user, the question being for the first user to obtain a response from a second user through a communication platform, retrieving related information of the obtained question using a vector database of a content previously registered by the second user, automatically generating an augmented prompt for generating a response to the question using a large language model (LLM), the augmented prompt including the related information of the question and the obtained question, transmitting the automatically generated augmented prompt to the LLM, receiving a response to the question from the LLM as a response to the transmission of the augmented prompt, and transmitting the response to the question received from the LLM to the terminal of the first user through the communication platform as a response of the second user.

### CROSS-REFERENCE TO RELATED APPLICATION

This application claims priority from Korean Patent Application No. 10-2025-0051433 filed on Apr. 21, 2025 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and apparatus for generating a personalized response. More specifically, the present disclosure relates to a method and apparatus for generating a personalized response to a question. 2. Description of the Related Art

Generative artificial intelligence (AI) technology has rapidly developed in recent years, and in particular, generative AI that generates text, images, codes, and the like, based on input of a user has been actively used. Such generative AI technology may be utilized to help the user with a specific task based on data and a command of the user.

However, existing generative AI technology operates in a manner of generating information according to an instruction of the user, and thus, has a limitation in autonomously generating personalized responses personalized to individual users. In particular, the existing generative AI technology lacks a function of responding to requests from other persons without intervention of the user or automatically performing sophisticated respondence reflecting an intention and a situation of the user.

That is, the existing generative AI technology may be effective in generating a standardized response, but lacks a function of generating responses optimized for individuals in an actual communication situation between users, and thus, there is a limitation in utilizing the existing generative AI technology as a practical work agent or automated response agent.

Accordingly, the necessity for technology for generating a personalized response capable of autonomously generating a response based on personalized information and automatically responding at an appropriate point in time without a direct instruction of a user has increased. Such technology may also perform an autopilot function of performing a response on behalf of the user beyond an existing generative AI system.

### SUMMARY

Aspects of the present disclosure provide a method and apparatus for generating a personalized response capable of generating a response reflecting personal data of a user.

Aspects of the present disclosure also provide a method and apparatus for generating a personalized response capable of generating a response to a question using a relationship between a questioner and a responser.

Aspects of the present disclosure also provide a method and apparatus for generating a personalized response capable of generating a response to a question using content access authority of a questioner.

Aspects of the present disclosure also provide a method and apparatus for generating a personalized response capable of automatically generating a response to a question when a questioner fails to receive a response to the question from a responser within a preset time.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for generating a personalized response, the method being performed by a computing system. The method comprises: obtaining a question from a terminal of a first user, the question being for the first user to obtain a response from a second user through a communication platform, retrieving related information of the obtained question using a vector database of a content previously registered by the second user, automatically generating an augmented prompt for generating a response to the question using a large language model (LLM), the augmented prompt including the related information of the question and the obtained question, transmitting the automatically generated augmented prompt to the LLM, receiving a response to the question from the LLM as a response to the transmission of the augmented prompt, and transmitting the response to the question received from the LLM to the terminal of the first user through the communication platform as a response of the second user.

In some embodiments, the method further comprises: obtaining a response style of the second user, the response style corresponding to any one of preset response types, automatically generating a prompt for generating a response to the question using the LLM, the prompt including the question and the obtained response style of the second user, transmitting the automatically generated prompt to the LLM, and receiving the response to the question from the LLM as a response to the transmission of the prompt.

In some embodiments, the obtaining of the response style includes obtaining the response style of the second user from a past conversation history between the second user and a conversation partner of the second user stored in the communication platform.

In some embodiments, the automatic generating of the augmented prompt includes automatically generating the augmented prompt only when the first user has failed to receive a response to the question of the first user from a terminal of the second user within a preset time from a point in time when the question was obtained from the terminal of the first user.

In some embodiments, the automatic generating of the augmented prompt includes: removing a non-core element included in the obtained question, summarizing the question from which the non-core element is removed so as to include characters fewer than a threshold value when the question from which the non-core element is removed includes characters of the threshold value or more, and automatically generating the augmented prompt including the summarized question and the related information of the question.

In some embodiments, the retrieving of the related information includes retrieving related information of the question whose similarity with the question is a threshold value or more from the vector database.

In some embodiments, the retrieving of the related information includes adjusting the threshold value to be higher as an amount of contents previously registered in the vector database increases.

In some embodiments, the retrieving of the related information includes: obtaining a request for storing an additional content to be used in the response to the question for the second user in a content group from the second user, the content group being a set of contents previously registered by the second user, and storing the additional content in the content group in response to the request of the second user.

In some embodiments, the retrieving of the related information includes: obtaining a request for storing at least some of a past conversation history between the second user and a conversation partner of the second user stored in the communication platform in a content group from the second user, the content group being a set of contents previously registered by the second user, and storing at least some of the past conversation history in the content group in response to the request of the second user.

In some embodiments, the retrieving of the related information includes: obtaining a question-specific response for the second user from a terminal of the second user and registering the obtained question-specific response as the content.

According to another aspect of the present disclosure, there is provided a method for generating a personalized response, the method being performed by a computing system. The method comprises: obtaining a question from a terminal of a first user, the question being for the first user to obtain a response from a second user, obtaining a relationship between the first user and the second user, determining a content group corresponding to the obtained relationship between the first user and the second user, and automatically generating a response to the obtained question using one or more contents included in the determined content group.

In some embodiments, the obtaining of the relationship between the first user and the second user includes an affiliation relationship in an organization between the first user and the second user.

In some embodiments, the determining of the content group includes determining the content group using content access authority corresponding to the obtained relationship between the first user and the second user.

In some embodiments, the automatic generating of the response includes generating the response to the question only when the first user has failed to receive a response to the question of the first user from the second user within a preset time from a point in time when the question was obtained from the first user.

In some embodiments, the automatic generating of the response includes: determining a content group including contents to be used in the response to the obtained question, determining a content whose relevance to the question is a threshold value or more among the contents included in the content group, and automatically generating the response to the question using the determined content.

In some embodiments, the determining of the content includes: obtaining a request for storing an additional content to be used in the response to the question for the second user in the content group from the second user, and storing the additional content in the content group in response to the request of the second user.

In some embodiments, the determining of the content includes: obtaining a request for storing at least some of a past conversation history between the second user and a conversation partner of the second user stored in a communication platform in the content group from the second user, and storing at least some of the past conversation history in the content group in response to the request of the second user.

According to still another aspect of the present disclosure, there is provided a method for generating a personalized response, the method being performed by a computing system. The method comprises: obtaining a question from a terminal of a first user, the question being for the first user to obtain a response from a second user, determining a content group corresponding to content access authority of the first user, and automatically generating a response to the obtained question using one or more contents included in the determined content group.

According to still another aspect of the present disclosure, there is provided an apparatus for generating a personalized response. The apparatus comprises: one or more processors, a memory loading a computer program executed by the one or more processors, and a storage storing the computer program, wherein the computer program includes: instructions for obtaining a question from a terminal of a first user, the question being for the first user to obtain a response from a second user through a communication platform, instructions for retrieving related information of the obtained question using a vector database of a content previously registered by the second user, instructions for automatically generating an augmented prompt for generating a response to the question using an LLM, the augmented prompt including the related information of the question and the obtained question, instructions for transmitting the automatically generated augmented prompt to the LLM, instructions for receiving a response to the question from the LLM as a response to the transmission of the augmented prompt, and instructions for transmitting the response to the question received from the LLM to the terminal of the first user through the communication platform as a response of the second user.

According to still another aspect of the present disclosure, there is provided an apparatus for generating a personalized response. The apparatus comprises: one or more processors, a memory loading a computer program executed by the one or more processors, and a storage storing the computer program, wherein the computer program includes: instructions for obtaining a question from a terminal of a first user, the question being for the first user to obtain a response from a second user, instructions for obtaining a relationship between the first user and the second user, instructions for determining a content group corresponding to the obtained relationship between the first user and the second user, and instructions for automatically generating a response to the obtained question using one or more contents included in the determined content group.

### BRIEF DESCRIPTION OF THE DRAWINGS

The above and other aspects and features of the present disclosure will become more apparent by describing in detail embodiments thereof with reference to the attached drawings, in which:

FIG. 1 is a block diagram illustrating a configuration of a system for generating a personalized response according to an exemplary embodiment of the present disclosure;

FIG. 2 is a flowchart of a method for generating a personalized response according to another exemplary embodiment of the present disclosure;

FIGS. 3 and 4 are diagrams for describing an example of generating a response to a question so as to reflect a response style of a second user in some exemplary embodiments;

FIG. 5 is a diagram for describing an example of obtaining a question-specific response of the second user in some exemplary embodiments;

FIG. 6 is a diagram for describing an example of storing an additional content in a content group in some exemplary embodiments;

FIGS. 7A to 7D is a diagram for describing an example of storing some of a past conversation history of the second user in a content group in some exemplary embodiments;

FIG. 8 is a flowchart of a method for generating a personalized response according to still another exemplary embodiment of the present disclosure;

FIG. 9 is a diagram for describing an example of a content group corresponding to a relationship between a first user and a second user in some exemplary embodiments;

FIG. 10 is a flowchart of a method for generating a personalized response according to still another exemplary embodiment of the present disclosure;

FIG. 11 is a diagram for describing an example of a content group corresponding to content access authority of a first user in some exemplary embodiments; and

FIG. 12 is a block diagram illustrating a hardware configuration of a computing apparatus described in some exemplary embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

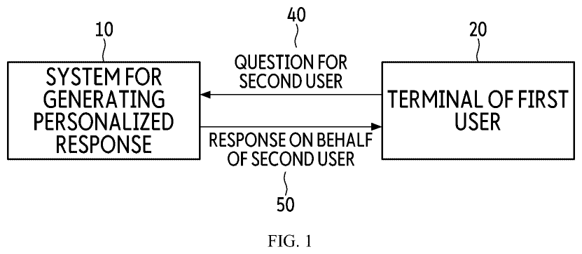

First, a configuration and an operation of a system for generating a personalized response according to an exemplary embodiment of the present disclosure will be described with reference to FIG. 1. FIG. 1 is a block diagram illustrating a configuration of a system for generating a personalized response according to the present exemplary embodiment.

A system 10 for generating a personalized response according to the present exemplary embodiment may obtain a question 40 for a second user from a terminal 20 of a first user. That is, the second user may refer to a subject that the first user wishes to ask a question. In addition, the system 10 for generating a personalized response according to the present exemplary embodiment may transmit a question 50 to the terminal of the first user on behalf of the second user as a response to the question 40 for the second user. In some exemplary embodiments, the system 10 for generating a personalized response according to the present exemplary embodiment may be configured as a computing server. In some exemplary embodiments, the terminal 20 of the first user may refer to a computing apparatus that obtains a question and provides a response to the question. For example, the terminal 20 of the first user may be a smartphone, a personal computer (PC), or the like. In some exemplary embodiments, the question 40 for the second user may be a question in the form of a voice natural language uttered by the first user. In some other exemplary embodiments, the question 40 for the second user may be a question in the form of a text input by the first user through a screen of the terminal 20 of the first user. In still other exemplary embodiments, the question 40 for the second user may be a question in the form of a text input by the second user through a communication platform. The communication platform may refer to a messenger or an e-mail platform.

It should be noted that the question 40 for the second user is not a question directly asked by the first user to a large language model (LLM) and is a question for obtaining a response from the second user. That is, in a case where the first user asks a question of the second user, when a specific condition is satisfied, the LLM may process the question, generate a response on behalf of the second user, and provide the response 50 to the first user. In some exemplary embodiments, the specific condition may refer to a case where the first user fails to obtain a response from the second user within a preset time from a point in time at which the question is obtained from the terminal 20 of the first user.

Hereinafter, several exemplary embodiments related to the generation of the response 50 by the system 10 for generating a personalized response according to the present exemplary embodiment will be introduced.

The system 10 for generating a personalized response may retrieve related information of the obtained question using a vector database of a content previously registered by the second user. In some exemplary embodiments, the related information of the obtained question may be a content previously registered by the second user so as to be used to generate the response to the question for the second user. In addition, the previously registered content may be vectorized and stored in the vector database. Accordingly, by using similarity between a vector value of the vector database and a vector value of the obtained question, related information having similarity of a reference value or more may be used to generate the response to the question for the second user. The similarity may be a value obtained by quantitatively evaluating semantic, contextual, or keyword-based similarity between the question and the content. As an example, the similarity may be evaluated by a term frequency-inverse document frequency (TF-IDF)-based similarity calculation. As another example, the similarity may be evaluated by a cosine similarity calculation using word embedding.

The system 10 for generating a personalized response may automatically generate an augmented prompt for generating the response to the question using the LLM, and the augmented prompt may include the related information of the question and the obtained question.

The system 10 for generating a personalized response may transmit the automatically generated augmented prompt to the LLM. Next, the system 10 for generating a personalized response may receive a response to the question from the LLM as a response to the transmission of the augmented prompt. Accordingly, the system 10 for generating a personalized response may transmit the response to the question received from the LLM to the terminal of the first user through the communication platform as a response of the second user. According to the present exemplary embodiment, the system 10 for generating a personalized response generates and transmits the response to the question of the first user on behalf of the second user, and thus, inconvenience of the second user may be reduced. In addition, the system 10 for generating a personalized response generates the response using a content whose relevance to the question is a reference value or more, and thus, may fast and accurately generate the response.

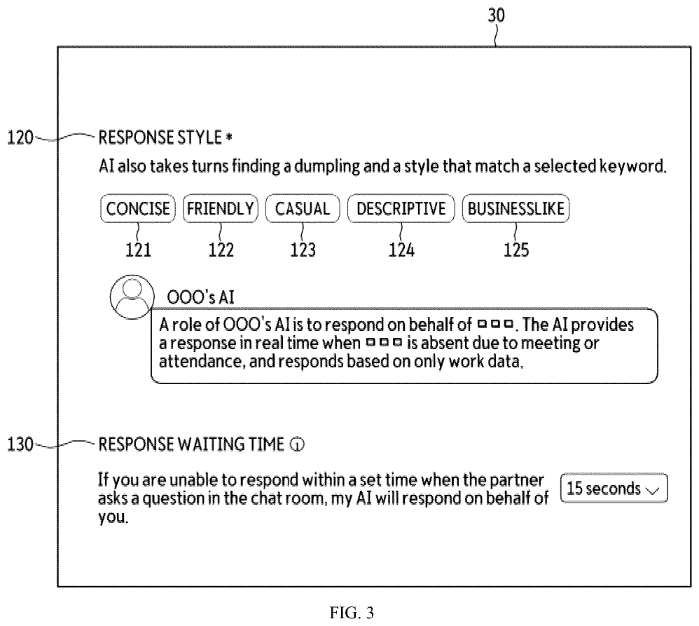

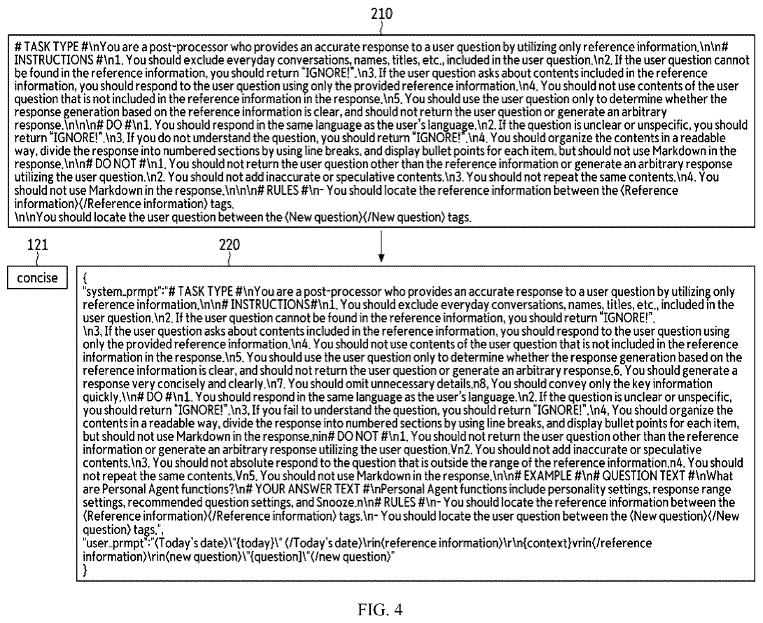

The system 10 for generating a personalized response may obtain a response style of the second user. In some exemplary embodiments, the response style of the second user may be information previously set by the second user. For example, the second user may set his/her response style in the system 10 for generating a personalized response before obtaining the question of the first user. In some other exemplary embodiments, the response style of the second user may be obtained from a past conversation history between the second user and a conversation partner of the second user stored in the communication platform where the question is asked. In some exemplary embodiments, the response style may correspond to any one of preset response types. In some other exemplary embodiments, the response style may include at least one of a length of a response, a vocabulary included in the response, and a tone of the response. A detailed example and description of the response style will be provided later with reference to FIGS. 3 and 4.

In addition, the system 10 for generating a personalized response may automatically generate a prompt for generating the response to the question using the LLM. In some exemplary embodiments, the prompt may include the question obtained from the terminal 20 of the first user and the obtained response style.

In some exemplary embodiments, the system 10 for generating a personalized response may transmit the automatically generated prompt to the LLM. In addition, a response to the question may be received from the LLM as a response to the transmission of the prompt. In addition, the system 10 for generating a personalized response according to the present exemplary embodiment may transmit the response to the terminal of the first user on behalf of the second user. According to the present exemplary embodiment, even though the second user does not directly respond to the question obtained from the first user, the response to the question may be transmitted to the first user on behalf of the second user, and thus, convenience of the second user may be increased. In addition, according to the present exemplary embodiment, the response reflecting the response style of the second user is transmitted to the first user, and thus, the first user may trust the response to the question and obtain a more natural response.

In addition, the system 10 for generating a personalized response may obtain a relationship between the first user and the second user. In some exemplary embodiments, the relationship between the first user and the second user may refer to an affiliation relationship in an organization between the first user and the second user. The affiliation relationship in an organization may be defined based on whether or not the first user and the second user are affiliated to the same organization. For example, the affiliation relationship in an organization may be defined based on whether or not the first user and the second user are affiliated to the same company, whether or not the first user and the second user are affiliated to the same department, whether or not the first user and the second user are affiliated to the same business department, or whether or not the first user and the second user are the same person. In some other exemplary embodiments, the relationship between the first user and the second user may include a trust level-based relationship. For example, the trust level-based relationship may be defined based on the number of past question-and-response exchanges between the first user and the second user. Accordingly, as the number of past question-and-response exchanges between the first user and the second user increases, an amount of contents included in a content group corresponding to the relationship between the first user and the second user may increase. In some other exemplary embodiments, the relationship between the first user and the second user may include a role relationship. For example, the first user may be a user of a specific system, and the second user may be an administrator of the specific system. In this case, a response to the question of the first user may be generated using only contents that may be disclosed to the user in the specific system.

In some exemplary embodiments, the system 10 for generating a personalized response according to the present exemplary embodiment may determine a content group corresponding to the obtained relationship between the first user and the second user. The content group may refer to a set of contents in which contents to be referenced in order to generate the response to the question obtained from the terminal of the first user are stored. That is, the content group may be a group in which contents for augmenting the prompt for generating the response to the question of the first user using a retrieval augmented generation (RAG) technique are stored. For example, the content group may refer to a folder in which data to be referenced in order to generate the response to the question obtained from the terminal of the first user is stored. In addition, the content group corresponding to the obtained relationship between the first user and the second user may refer to a content group in which contents accessible according to content access authority corresponding to the relationship between the first user and the second user are stored. For example, when the first user and the second user are affiliated to the same business department, a content group in which contents accessible according to content access authority corresponding to the same business department are stored may be determined.

In some exemplary embodiments, a response to the obtained question may be automatically generated using one or more contents included in the determined content group. That is, the response to the obtained question may be automatically generated by the system 10 for generating a personalized response rather than by the second user. According to the present exemplary embodiment, since the response to the question is generated using one or more contents included in the content group corresponding to the relationship between the first user and the second user, the response may be automatically generated excluding information that the second user does not wish to disclose to the first user for a security reason or the like.

The system 10 for generating a personalized response may determine a content group corresponding to content access authority of the first user. The content access authority may refer to access authority to contents to be referenced when automatically generating the response to the question of the first user. In addition, the system 10 for generating a personalized response according to the present exemplary embodiment may automatically generate the response to the obtained question using one or more contents included in the determined content group.

The system for generating a personalized response according to the present exemplary embodiment may be understood in more detail with reference to other exemplary embodiments to be described later. In addition, a technical idea that may be understood through the above-described exemplary embodiments of the system for generating a personalized response according to the present exemplary embodiment may be reflected in other exemplary embodiments to be described later even though not specified separately.

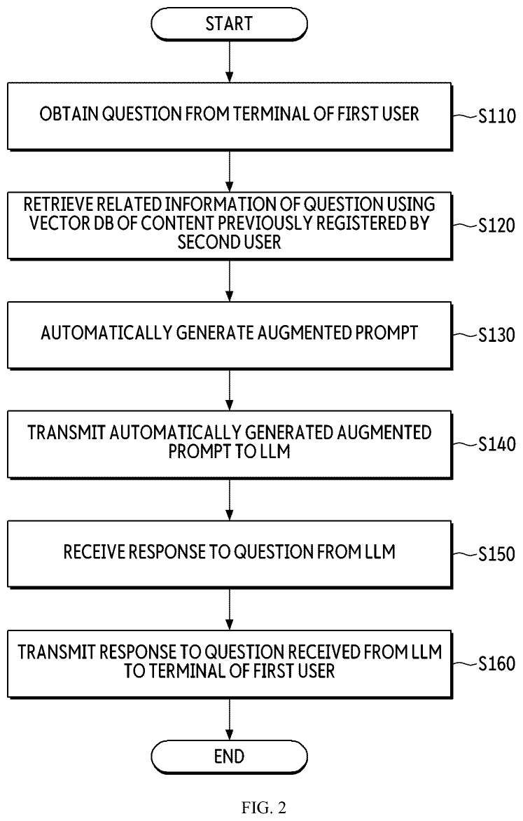

Next, a method for generating a personalized response according to another exemplary embodiment of the present disclosure will be described with reference to FIG. 2. FIG. 2 is a flowchart of a method for generating a personalized response according to another exemplary embodiment of the present disclosure.

The method for generating a personalized response according to the present exemplary embodiment may be performed by a computing system. For example, all operations of the method for generating a personalized response according to the present exemplary embodiment may be performed by a single computing apparatus or performed by a plurality of computing apparatuses. That is, some operations of the method for generating a personalized response according to the present exemplary embodiment may be performed by a first computing apparatus and the other operations of the method for generating a personalized response according to the present exemplary embodiment may be performed by a second computing apparatus. Hereinafter, a description of an entity of each operation may be omitted in describing each operation. In such a case, it will be understood that an entity of each operation is the computing apparatus. In addition, it should be noted that exemplary embodiments of the system for generating a personalized response described with reference to FIG. 1 may be naturally applied to the method for generating a personalized response according to the present exemplary embodiment unless otherwise stated.

In some exemplary embodiments, a question may be obtained from the terminal of the first user (S110). The question may be for the first user to obtain a response from the second user through the communication platform. That is, the question may refer to a message input by the first user through a chat window of the communication platform. It should be noted that the present exemplary embodiment relates to a method in which the LLM generates a response of the second user to the question of the first user on behalf of the second user and transmits the response to the first user, rather than a form in which the first user asks a question of the LLM and the LLM generates the response to the question.

In some exemplary embodiments, the computing system that performs the method for generating a personalized response according to the present exemplary embodiment may retrieve related information of the obtained question using a vector database of a content previously registered by the second user (S120). In some exemplary embodiments, the content may be data in the form of a file. According to S120, a personalized response may be generated using data that the second user actively wishes to include when generating the response.

In some exemplary embodiments, an augmented prompt for generating the response to the question using the LLM may be automatically generated (S130). In addition, the augmented prompt may include the related information of the question and the obtained question. According to S130, since the response to the question may be generated by utilizing the question as an input value together with a content having high relevance to the question, a response having high accuracy and appropriate for a context may be generated.

In some exemplary embodiments, the automatically generated augmented prompt may be transmitted to the LLM (S140). Next, the computing system that performs the method for generating a personalized response according to the present exemplary embodiment may receive a response to the question from the LLM as a response to the transmission of the augmented prompt (S150). Next, the computing system may transmit the response to the question received from the LLM to the terminal of the first user through the communication platform as the response of the second user (S160). According to the present exemplary embodiment, the first user feels as if he/she has directly received the response of the second user, such that a natural communication environment may be realized.

In some exemplary embodiments, the response to the question of the first user may be generated using the response style of the second user. The response style may correspond to any one of preset response types. For example, the preset response types may include a concise response type, a friendly response type, a casual response type, a descriptive response type, and a businesslike response type.

In some exemplary embodiments, the response style may be determined from a past conversation history between the second user and a conversation partner of the second user stored in the communication platform. Specifically, in some exemplary embodiments, the past conversation history between the second user and the conversation partner of the second user stored in the communication platform such as an e-mail or a messenger may be obtained. Next, a conversation history of the second user may be extracted from the obtained past conversation history. Next, a length of the response and a vocabulary selection tendency included in the response may be extracted from the extracted conversation history of the second user. Accordingly, the response style of the second user may be determined using the extracted length of the response and the extracted vocabulary selection tendency included in the response. The conversation partner of the second user may refer to not only the first user, but also a user who has previously chatted or exchanged conversations with the second user through the communication platform.

In some exemplary embodiments, a prompt for generating the response to the question using the LLM may be automatically generated. That is, the prompt may be automatically generated by the computing apparatus. In addition, the prompt may include information on the question and the obtained response style of the second user. An example of automatically generating the prompt is described with reference to FIGS. 3 and 4.

FIGS. 3 and 4 are diagrams for describing an example of generating a response to a question so as to reflect a response style of a second user in some exemplary embodiments.

As illustrated in FIG. 3, a preset profile of the second user may be displayed on a screen of a terminal 30 of the second user. The profile of the second user may include information on a response style 120 of the second user and a response waiting time 130.

In addition, the response style 120 is a response style to be reflected when the LLM generates the response to the question for the second user on behalf of the second user, and may include a concise response style 121, a friendly response style 122, a casual response style 123, a descriptive response style 124, and a businesslike response style 125. For example, the concise response style 121 may refer to a response style that includes only core contents of the question. In addition, the friendly response style 122 may refer to a response style that includes an easy-to-understand response and friendly vocabulary use. Further, the casual response style 123 may refer to a response style that includes casual and everyday vocabulary use. Further, the descriptive response style 124 may refer to a response style in which a context and a reason for the response are explained in detail. Further, the businesslike response style 125 may refer to a response style that uses formal and professional vocabulary.

In addition, the response waiting time 130 may refer to a time taken for the computing apparatus to grasp a context of the question of the first user and determine to generate the response to the question for the second user on behalf of the second user since the question for the second user was requested. For example, when the response waiting time 130 is 15 seconds, this may be used in two ways. First, when the first user performs continuous conversations and questions within 15 seconds, all questions may be bundled into and utilized as a question bundle at a point in time when a question after 15 seconds is confirmed. Next, when the second user does not respond to the question until 15 seconds have elapsed from a point in time when the question for the second user is obtained, the response to the question may be automatically generated on behalf of the second user.

In some exemplary embodiments, the second user may modify a profile of the second user using the terminal 30 of the second user. In addition, the second user may modify the response style of the second user from the friendly response style 121 to the casual response style 123. In addition, the second user may increase or decrease the response waiting time 130.

The setting of the profile of the second user including the response style of the second user has been described in detail with reference to FIG. 3. Hereinafter, automatic generation of a prompt reflecting the response style of the second user will be described in detail with reference to FIG. 4.

In some exemplary embodiments, as illustrated in FIG. 4, a prompt including the question of the first user and the response style of the second user may be automatically generated. In some exemplary embodiments, a prompt including the question of the first user may be automatically generated, and may then be modified to include the response style of the second user. For example, as illustrated in FIG. 4, a prompt 210 including the question of the first user may be automatically generated, and a prompt 220 including the concise response style 121 among response style information of the second user may be automatically generated from the prompt 210. In some other exemplary embodiments, a prompt including the question of the first user and the response style of the second user may be immediately generated.

So far, the example of automatically generating the prompt including the response style of the second user has been described in detail with reference to FIGS. 3 and 4. Hereinafter, the method for generating a personalized response according to another exemplary embodiment of the present disclosure will be described with reference to FIG. 2 again.

In some exemplary embodiments, a non-core element included in the obtained question may be removed in S130. The non-core element may refer to an element unrelated to the obtained question. For example, the non-core element is a small talk included in the obtained question, and may refer to an element unrelated to the obtained question, such as formal greetings.

In addition, in some exemplary embodiments, when the question from which the non-core element is removed includes characters of a threshold value or more, the question from which the non-core element is removed may be summarized so as to include characters fewer than the threshold value. For example, when the question from which the non-core element is removed includes 100 or more characters, the question from which the non-core element is removed may be summarized so as to include characters fewer than 100 characters. Next, an augmented prompt including the summarized question and related information of the question may be automatically generated. According to the present exemplary embodiments, by performing preprocessing before automatically generating the prompt for generating the response to the question using the LLM, a prompt for receiving a response having high accuracy from the LLM may be automatically generated.

In some exemplary embodiments, in S120, the computing system that performs the method for generating a personalized response according to the present exemplary embodiment may retrieve related information of the question whose similarity with the question is a threshold value or more from the vector database.

In addition, in some exemplary embodiments, as an amount of vector data corresponding to the contents previously registered in the vector database increases, a threshold value when deciding relevance to the question may be adjusted to be high. For example, when an amount of first content of first and second contents included in the content group is greater than an amount of second content of the first and second contents, a threshold value corresponding to the first content may be determined to be higher than a threshold value corresponding to the second content when relevance to the question is decided. According to the present exemplary embodiment, when the relevance to the question is decided for a content having a relatively great amount of information, a reference for deciding the relevance may be set relatively strictly. Accordingly, unnecessary information included in the content is not referenced when the response to the question is generated, such that the accuracy of the response may be increased.

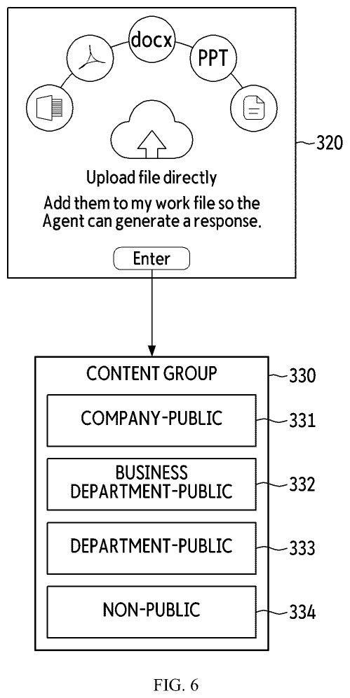

In addition, in some exemplary embodiments, a request for storing an additional content to be used in the response to the question for the second user in the content group may be obtained from the second user. Accordingly, the additional content may be stored in the content group in response to the request of the second user. The content group may be a set of contents previously registered by the second user. That is, the content may be data previously registered by the second user, the content group may be a set of the contents, and vectorized data of the contents may be stored in the vector database. A specific example of storing the additional content in the content group will be described later with reference to FIG. 6. Accordingly, when the response to the question for the second user is generated, the additional content stored in the content group may be used.

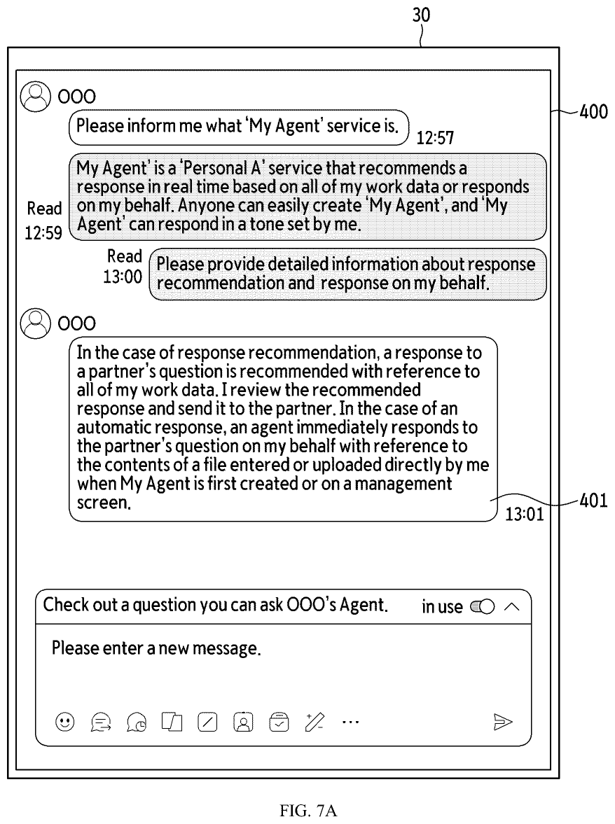

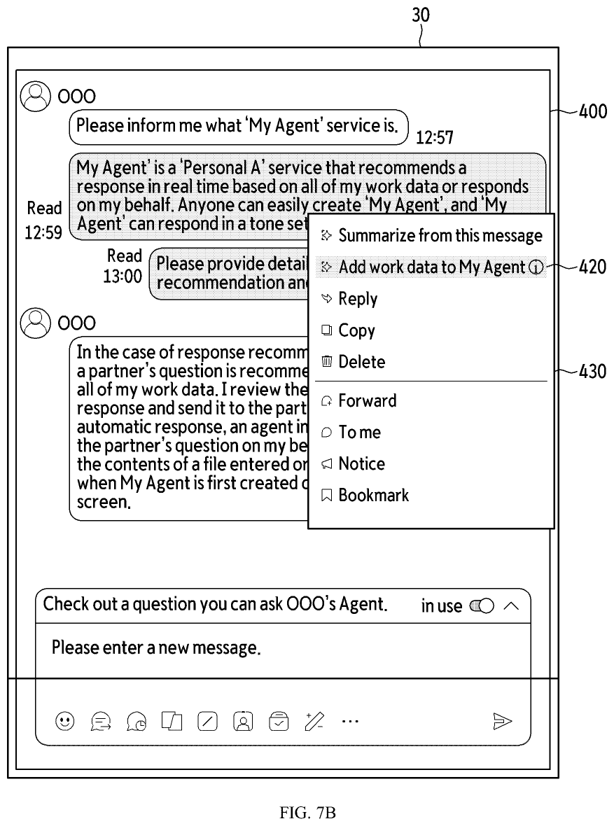

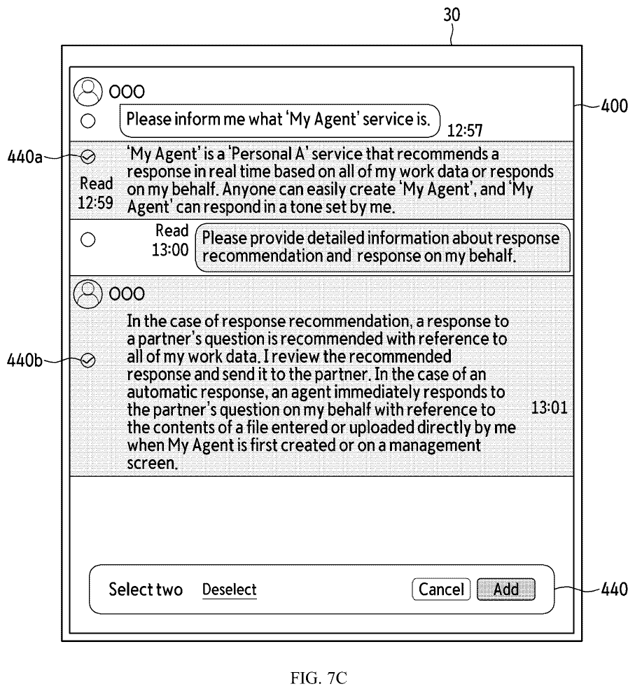

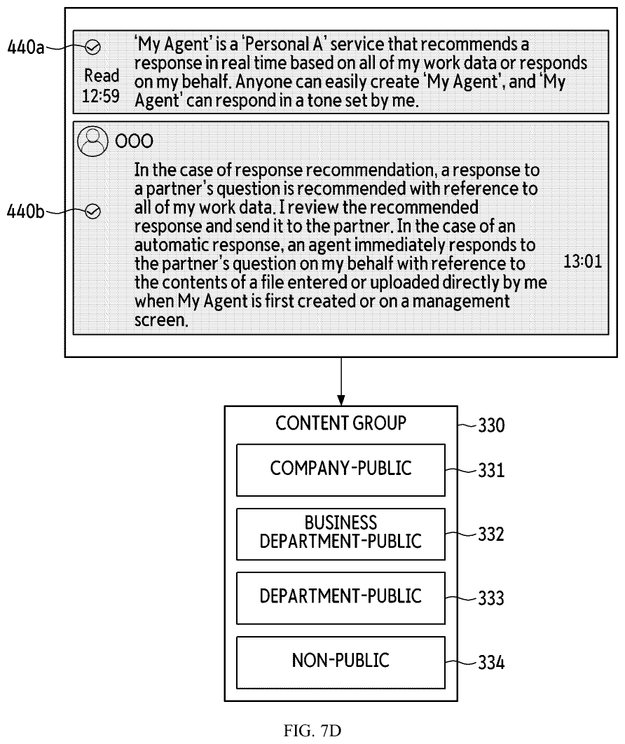

In addition, in some exemplary embodiments, a request for storing at least some of the past conversation history between the second user and the conversation partner of the second user stored in the communication platform in the content group may be obtained from the second user. For example, the second user may select some of the past conversation history and request that some of the past conversation history are stored in the content group. The conversation partner of the second user may refer to not only the first user, but also a user who has exchanged conversations with the second user through a messenger platform or an e-mail platform. In addition, the past conversation history may include chatting contents or e-mail contents stored in the communication platform. At least some of the past conversation history may be stored in the content group in response to the request of the second user. Accordingly, when the response to the question for the second user is generated, at least some of the past conversation history may be used. An example in which a request for storing at least some of the past conversation history in the content group is obtained and at least some of the past conversation history is stored in the content group will be described below with reference to FIGS. 7A to 7D.

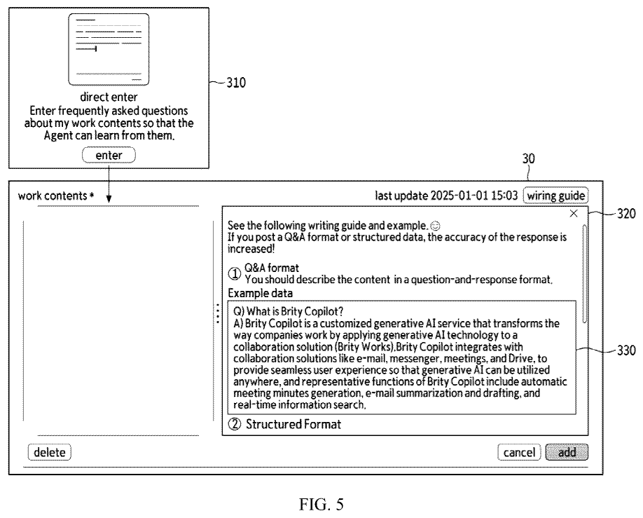

In addition, in some exemplary embodiments, a question-specific response for the second user may be obtained, and a response to the obtained question may be obtained using the obtained question-specific response. The question-specific response may be a predetermined response to a specific question when the specific question is obtained for the second user. For example, when a question for asking about an affiliation of the second user in an organization is obtained, the affiliation of the second user in the organization may be the question-specific response. That is, the question-specific response may refer to a predefined response template. Accordingly, when a question corresponding to the question-specific response is obtained, a response to the question may be quickly generated using the question-specific response. A specific example of the question-specific response will be described later with reference to FIG. 5.

In some exemplary embodiments, the automatically generated prompt may be transmitted to the LLM (S140). In addition, a response to the question may be received from the LLM as a response to the transmission of the prompt (S150). In addition, the computing system that performs the method for generating a personalized response according to the present exemplary embodiment may transmit the response to the question received from the LLM to the terminal of the first user.

So far, the method for generating a personalized response according to another exemplary embodiment of the present disclosure has been entirely described with reference to FIG. 2. Hereinafter, a specific exemplary embodiment of generating a response to a question will be described in detail.

FIG. 5 is a diagram for describing an example of obtaining a question-specific response of the second user in some exemplary embodiments.

In some exemplary embodiments, as illustrated in FIG. 5, a question-specific response for the second user may be obtained. As illustrated in FIG. 5, the second user may input a question-specific response for the second user to the computing system that performs the method for generating a personalized response according to the present exemplary embodiment, through the terminal 30 of the second user (310). In addition, a guidance 320 for a method for inputting the question-specific response may be displayed on the terminal of the second user. The guidance 320 for the method for inputting the question-specific response may include an example 330 of the question-specific response. As illustrated in FIG. 5, the question-specific response may refer to a response in a Q&A format or a structured format. For example, a response in a Q&A format or a structured format corresponding to the question for the second user as in 330 may be the question-specific response. When the question-specific response is obtained, a response to the question of the first user may be obtained using the question-specific response. According to the present exemplary embodiment, by inputting the question-specific response structured in advance in the computing system, an accurate response to a repetitive question may be provided without additional memory waste.

FIG. 6 is a diagram for describing an example of storing an additional content in a content group in some exemplary embodiments.

In some exemplary embodiments, as illustrated in FIG. 6, a request for storing an additional content to be referenced in the response to the question for the second user in the content group may be obtained from the second user. That is, as illustrated in FIG. 6, the second user may upload the additional content to be referenced in the response to the question for the second user to the content group (320). The additional content may be stored in a content group 330 in response to the request of the second user. In addition, in some exemplary embodiments, the additional content may be stored in any one of a company-public content group 331, a business department-public content group 332, a department-public content group 333, and a non-public content group 334 included in the content group 330 in response to the request of the second user. Accordingly, when the response to the question for the second user is generated, the additional content stored in the content group 330 may be used. According to the present exemplary embodiment, up-to-date information may be stored as the additional content in the content group 330, and thus, a response having high accuracy and optimized for an individual may be generated.

FIGS. 7A to 7D is a diagram for describing an example of storing some of a past conversation history of the second user in a content group in some exemplary embodiments.

In some exemplary embodiments, as illustrated in FIGS. 7A to 7D, a request for storing at least some of the past conversation history between the second user and the conversation partner of the second user stored in the communication platform in the content group may be received from the second user.

As illustrated in FIG. 7A, in some exemplary embodiments, a past conversation history 400 between the second user and the conversation partner of the second user stored in the communication platform may be disposed on the terminal 30 of the second user. In addition, in some exemplary embodiments, when the first user asks a question for the second user, the first user may determine whether or not to obtain the response using the LLM (401). For example, when the first user obtains the response to the question from the second user, the first user may determine whether to obtain the response directly from the second user or obtain the response using the LLM on behalf of the second user. Accordingly, according to the present exemplary embodiment, the first user may flexibly select any one of a method for directly interacting with the second user and a method for using the LLM on behalf of the second user.

As illustrated in FIG. 7B, in some exemplary embodiments, an additional function 430 for at least some of the past conversation history 400 may be provided in a drop-down form from the second user. The additional function 430 may include a request 420 for storing at least some of the past conversation history 400 in the content group. According to the present exemplary embodiment, by providing the additional function through a drop-down user interface (UI), a user experience may be improved, and the additional function may be intuitively managed.

As illustrated in FIG. 7C, in some exemplary embodiments, some 440a and 440b of the past conversation history 400 requested by the second user so as to be stored in the content group may be selected through the terminal 30 of the second user (440). According to the present exemplary embodiment, since the user may select required conversations by himself/herself, accuracy and quality of a content included in the content group may be improved, such that accuracy of the response to the question may be improved.

As illustrated in FIG. 7D, in some exemplary embodiments, some 440a and 440b selected among the past conversation history 400 may be stored in the content group 330 in response to the request of the second user. According to the present exemplary embodiment, some selected among the past conversation history may be stored in the content group, such that accuracy of the response when generating the response using the RAG technique may be improved.

So far, the method for generating a personalized response according to another exemplary embodiment of the present disclosure has been described. Hereinafter, a method for generating a personalized response according to still another exemplary embodiment of the present disclosure will be described.

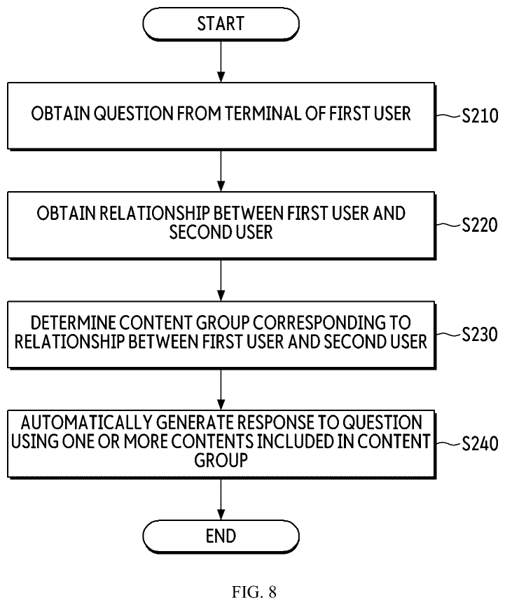

FIG. 8 is a flowchart of a method for generating a personalized response according to still another exemplary embodiment of the present disclosure.

In some exemplary embodiments, a question may be obtained from the terminal of the first user (S210). In addition, the question may be for the first user to obtain a response from the second user.

In some exemplary embodiments, a relationship between the first user and the second user may be obtained (S220). In S220, an affiliation relationship in an organization between the first user and the second user may be obtained. The affiliation relationship in an organization may be defined based on whether or not the first user and the second user are affiliated to the same organization. For example, the affiliation relationship in an organization may be defined based on whether or not the first user and the second user are affiliated to the same company, whether or not the first user and the second user are affiliated to the same department, whether or not the first user and the second user are affiliated to the same business department, or whether or not the first user and the second user are the same person.

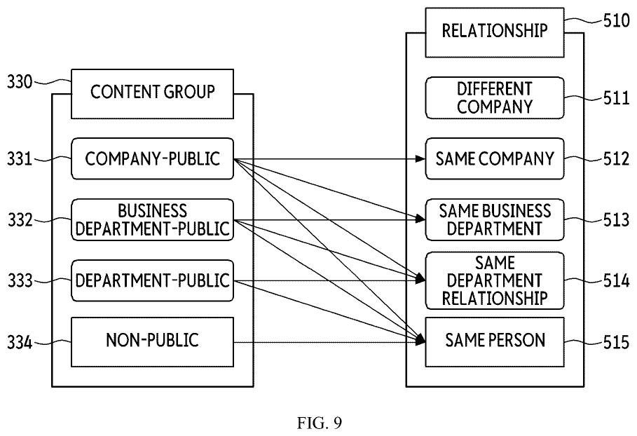

In some exemplary embodiments, a content group corresponding to the obtained relationship between the first user and the second user may be determined (S230). In S230, the content group may be determined using content access authority corresponding to the obtained relationship between the first user and the second user. An example of the content group corresponding to the relationship between the first user and the second user will be described later with reference to FIG. 9.

In some exemplary embodiments, a response to the obtained question may be automatically generated using one or more contents included in the determined content group (S240). In S240, the response to the question may be generated only when the first user has failed to receive a response to the question of the first user from the second user within a preset time from a point in time when the question was obtained from the first user. In addition, in S240, a content group including contents to be referenced in the response to the obtained question may be determined, a content whose relevance to the question is a threshold value or more among the contents included in the content group may be determined, and the response to the question may be automatically generated using the determined content. In addition, in some exemplary embodiments, a request for storing an additional content to be referenced in the response to the question for the second user in the content group may be obtained from the second user, and the additional content may be stored in the content group in response to the request of the second user. A detailed example of storing the additional content in the content group in response to the request of the second user has been described above with reference to FIG. 6.

In some other exemplary embodiments, a request for storing at least some of the past conversation history between the second user and the conversation partner of the second user stored in the communication platform in the content group may be obtained from the second user, and at least some of the past conversation history may be stored in the content group in response to the request of the second user. A specific example of storing at least some of the past conversation history in the content group in response to the request of the second user has been described above with reference to FIGS. 7A to 7D.

FIG. 9 is a diagram for describing an example of a content group corresponding to a relationship between a first user and a second user in some exemplary embodiments.

As illustrated in FIG. 9, a content group 330 may include a company-public content group 331, a business department-public content group 332, a department-public content group 333, and a non-public content group 334. In addition, a relationship 510 between the first user and the second user may include a different company relationship 511, a same company relationship 512, a same business department relationship 513, a same department relationship 514, and a same person relationship 515.

Referring to FIG. 9, the company-public content group 331 may permit access to the content when the relationship 510 is the same company relationship 512, the same business department relationship 513, the same department relationship 514, or the same person relationship 515. In addition, the business department-public content group 332 may permit access to the content when the relationship 510 is the same business department relationship 513, the same department relationship 514, or the same person relationship 515. In addition, the department-public content group 333 may permit access to the content when the relationship 510 is the same department relationship 514 or the same person relationship 515. In addition, the non-public content group 334 may permit access to the content only when the relationship 510 is the same person relationship 515.

That is, when the relationship 510 between the first user and the second user is the different company relationship 511, access to the content in the content group 330 is not permitted. In addition, when the relationship 510 between the first user and the second user is the same company relationship 512, access to the content in the company-public content group 331 is permitted. Further, when the relationship 510 between the first user and the second user is the same business department relationship 513, access to the contents in the company-public content group 331 and the business department-public content group 332 is permitted. Further, when the relationship 510 between the first user and the second user is the same department relationship 514, access to the contents in the company-public content group 331, the business department-public content group 332, and the department-public content group 333 is permitted. Further, when the relationship 510 between the first user and the second user is the same person relationship 515, access to the contents in the company-public content group 331, the business department-public content group 332, the department-public content group 333, and the non-public content group 334 is permitted.

Accordingly, according to the present exemplary embodiment, since the response to the question of the first user may be generated using only the content corresponding to the relationship between the first user and the second user, a security issue due to information leakage may be solved, and a more personalized response may be generated.

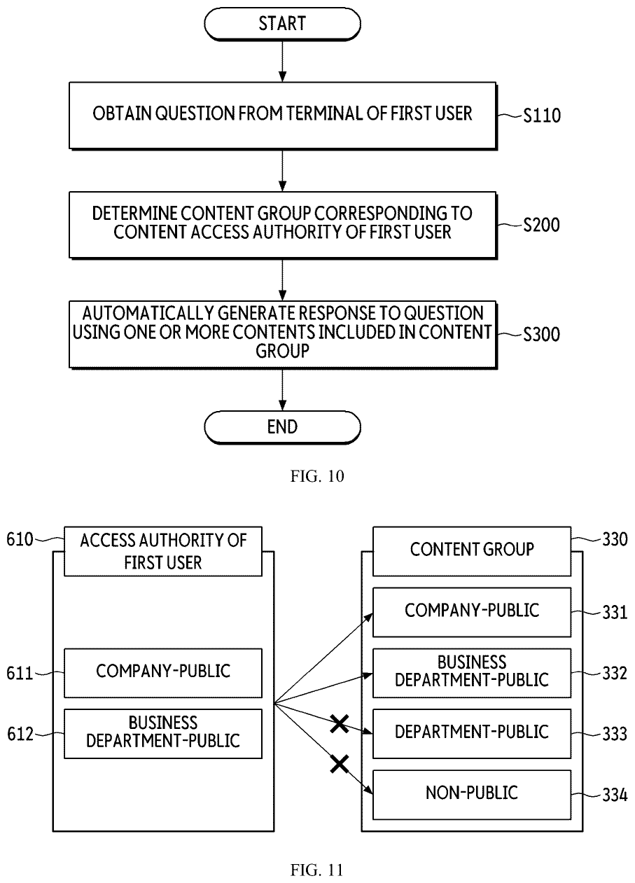

FIG. 10 is a flowchart of a method for generating a personalized response according to still another exemplary embodiment of the present disclosure.

In some exemplary embodiments, a question may be obtained from the terminal of the first user (S110). In addition, the question may be for the first user to obtain a response from the second user. That is, the present exemplary embodiment is distinguished from an operation in which the first user directly asks a question of the LLM.

In some exemplary embodiments, a content group corresponding to content access authority of the first user may be determined (S200). That is, the content group determined in S200 may limit a range of contents referenced to generate a response to the question of the first user using the RAG technique. According to the present exemplary embodiment, reference contents of RAG are configured only by contents permitted to the first user, such that information security and accuracy of the response may be improved.

In some exemplary embodiments, a response to the obtained question may be automatically generated using one or more contents included in the determined content group (S300). According to the present exemplary embodiment, by automating the response through the LLM on behalf of the second user, response burden of the second user may be reduced, and the first user may quickly receive the response to the question.

FIG. 11 is a diagram for describing an example of a content group corresponding to content access authority of a first user in some exemplary embodiments.

As illustrated in FIG. 11, when access authority 610 of the first user is company-public authority 611 and business department-public authority 612, a company-public content group 331 and a business department-public content group 332 in a content group 330 may be content groups corresponding to content access authority of the first user. Accordingly, when a response to the question of the first user is generated, contents included in the company-public content group 331 and the business department-public content group 332 may be used, but contents included in a department-public content group 333 and a non-public content group 334 may not be used.

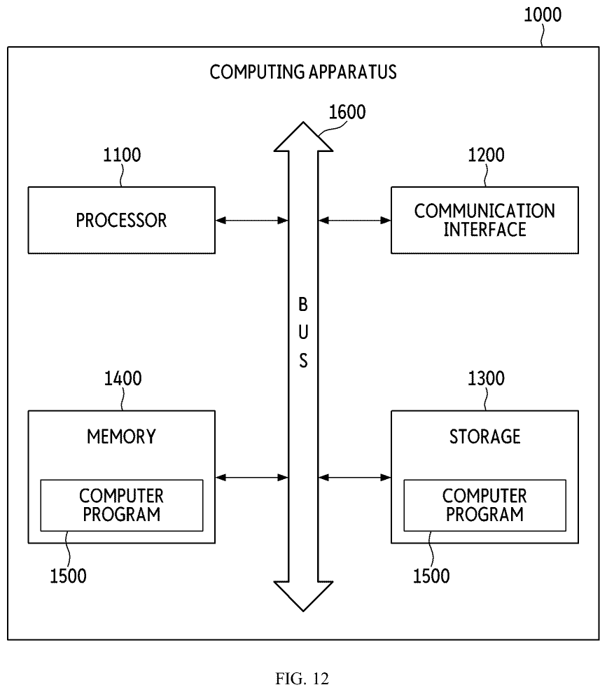

FIG. 12 is a block diagram illustrating a hardware configuration of a computing apparatus described in some exemplary embodiments of the present disclosure.

Referring to FIG. 12, the computing apparatus 1000 may include one or more processors 1100, a bus 1600, a communication interface 1200, a memory 1400 loading a computer program 1500 executed by the processor 1100, and a storage 1300 storing the computer program 1500. However, only components related to an exemplary embodiment of the present disclosure have been illustrated in FIG. 12. Accordingly, one of ordinary skill in the art to which the present disclosure pertains may understand that the computing apparatus 500 may further include other general-purpose components in addition to the components illustrated in FIG. 12. That is, the computing apparatus 1000 may further include various components in addition to the components illustrated in FIG. 12. In addition, in some cases, the computing apparatus 1000 may be configured in a form in which some of the components illustrated in FIG. 12 are omitted. Hereinafter, respective components of the computing apparatus 1000 will be described. Meanwhile, the terms “computing apparatus 1000” and “computing system” may be used interchangeably throughout the present disclosure.

The processor 1100 may control overall operations of the respective components of the computing apparatus 1000. The processor 1100 may be configured to include at least one of a central processing unit (CPU), a micro processor unit (MPU), a micro controller unit (MCU), a graphic processing unit (GPU), or any type of processor well known in the art to which the present disclosure pertains. In addition, the processor 1100 may perform an arithmetic operation on at least one application or program for executing operations/methods according to exemplary embodiments of the present disclosure. The computing apparatus 1000 may include one or more processors.

Next, the memory 1400 may store various data, commands, and/or information. The memory 1400 may load the computer program 1500 from the storage 1300 in order to execute the operations/methods according to exemplary embodiments of the present disclosure. The memory 1400 may be implemented as a volatile memory such as a random access memory (RAM), but the present disclosure is not limited thereto.

Next, the bus 1600 may provide a communication function between the components of the computing apparatus 1000. The bus 1600 may be implemented as various types of buses such as an address bus, a data bus, and a control bus.

Next, the communication interface 1200 may support wired/wireless Internet communication of the computing apparatus 1000. In addition, the communication interface 1200 may support various communication methods other than the Internet communication. To this end, the communication interface 1200 may be configured to include a communication module well known in the art to which the present disclosure pertains.

Next, the storage 1300 may non-temporarily store one or more computer programs 1500. The storage 1300 may be configured to include a non-volatile memory such as a flash memory, a hard disk, a removable disk, or any type of computer-readable recording medium well known in the art to which the present disclosure pertains.

Next, the computer program 1500 may include one or more instructions for causing the processor 1100 to perform operations/methods according to various exemplary embodiments of the present disclosure when they are loaded into the memory 1400. That is, the processor 1100 may perform the operations/methods according to various exemplary embodiments of the present disclosure by executing the loaded one or more instructions.

For example, the computing apparatus of FIG. 12 may be a computing apparatus included in the system 10 for generating a personalized response described with reference to FIG. 1. In this case, the computing apparatus described with reference to FIG. 12 may be configured using one or more physical servers included in a server farm based on cloud technology such as a virtual machine. In this case, at least some of the processor 1100, the memory 1400, and the storage 1300 of the components illustrated in FIG. 12 may be virtual hardware, and the communication interface 1200 may also be configured as a virtualized networking element such as a virtual switch.

The computer program 1500 according to an exemplary embodiment may include instructions for obtaining a question from a terminal of a first user, the question being for the first user to obtain a response from a second user through a communication platform, instructions for determining a content group including contents to be used in a response to the obtained question, instructions for determining a content whose relevance to the question is a threshold value or more among the contents included in the content group, instructions for automatically generating an augmented prompt for generating a response to the question using a large language model (LLM), the augmented prompt including a content whose relevance to the question is determined to be the threshold value or more and the obtained question, instructions for transmitting the automatically generated augmented prompt to the LLM, instructions for receiving a response to the question from the LLM as a response to the transmission of the augmented prompt, and instructions for transmitting the response to the question received from the LLM to the terminal of the first user through the communication platform as a response of the second user.

So far, a variety of embodiments of the present disclosure and the effects according to embodiments thereof have been mentioned with reference to FIGS. 1 to 12. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation.

What is claimed is:

1. A method for generating a personalized response, the method being performed by a computing system, comprising:
obtaining a question from a terminal of a first user, the question being for the first user to obtain a response from a second user through a communication platform;
retrieving related information of the obtained question using a vector database of a content previously registered by the second user;
automatically generating an augmented prompt for generating a response to the question using a large language model (LLM), the augmented prompt including the related information of the question and the obtained question;
transmitting the automatically generated augmented prompt to the LLM;
receiving a response to the question from the LLM as a response to the transmission of the augmented prompt; and
transmitting the response to the question received from the LLM to the terminal of the first user through the communication platform as a response of the second user.

2. The method of claim 1, further comprising:
obtaining a response style of the second user, the response style corresponding to any one of preset response types;
automatically generating a prompt for generating a response to the question using the LLM, the prompt including the question and the obtained response style of the second user;
transmitting the automatically generated prompt to the LLM; and
receiving the response to the question from the LLM as a response to the transmission of the prompt.

3. The method of claim 2, wherein the obtaining of the response style includes obtaining the response style of the second user from a past conversation history between the second user and a conversation partner of the second user stored in the communication platform.

4. The method of claim 1, wherein the automatic generating of the augmented prompt includes automatically generating the augmented prompt only when the first user has failed to receive a response to the question of the first user from a terminal of the second user within a preset time from a point in time when the question was obtained from the terminal of the first user.

5. The method of claim 1, wherein the automatic generating of the augmented prompt includes:
removing a non-core element included in the obtained question;
summarizing the question from which the non-core element is removed so as to include characters fewer than a threshold value when the question from which the non-core element is removed includes characters of the threshold value or more; and
automatically generating the augmented prompt including the summarized question and the related information of the question.

6. The method of claim 1, wherein the retrieving of the related information includes retrieving related information of the question whose similarity with the question is a threshold value or more from the vector database.

7. The method of claim 6, wherein the retrieving of the related information includes adjusting the threshold value to be higher as an amount of contents previously registered in the vector database increases.

8. The method of claim 1, wherein the retrieving of the related information includes:
obtaining a request for storing an additional content to be used in the response to the question for the second user in a content group from the second user, the content group being a set of contents previously registered by the second user; and
storing the additional content in the content group in response to the request of the second user.

9. The method of claim 1, wherein the retrieving of the related information includes:
obtaining a request for storing at least some of a past conversation history between the second user and a conversation partner of the second user stored in the communication platform in a content group from the second user, the content group being a set of contents previously registered by the second user; and
storing at least some of the past conversation history in the content group in response to the request of the second user.

10. The method of claim 1, wherein the retrieving of the related information includes:
obtaining a question-specific response for the second user from a terminal of the second user; and
registering the obtained question-specific response as the content.

11. A method for generating a personalized response, the method being performed by a computing system, comprising:
obtaining a question from a terminal of a first user, the question being for the first user to obtain a response from a second user;
obtaining a relationship between the first user and the second user;
determining a content group corresponding to the obtained relationship between the first user and the second user; and
automatically generating a response to the obtained question using one or more contents included in the determined content group.

12. The method of claim 11, wherein the obtaining of the relationship between the first user and the second user includes an affiliation relationship in an organization between the first user and the second user.

13. The method of claim 11, wherein the determining of the content group includes determining the content group using content access authority corresponding to the obtained relationship between the first user and the second user.

14. The method of claim 11, wherein the automatic generating of the response includes generating the response to the question only when the first user has failed to receive a response to the question of the first user from the second user within a preset time from a point in time when the question was obtained from the first user.

15. The method of claim 11, wherein the automatic generating of the response includes:
determining a content group including contents to be used in the response to the obtained question,
determining a content whose relevance to the question is a threshold value or more among the contents included in the content group; and
automatically generating the response to the question using the determined content.

16. The method of claim 15, wherein the determining of the content includes:
obtaining a request for storing an additional content to be used in the response to the question for the second user in the content group from the second user; and
storing the additional content in the content group in response to the request of the second user.

17. The method of claim 15, wherein the determining of the content includes:
obtaining a request for storing at least some of a past conversation history between the second user and a conversation partner of the second user stored in a communication platform in the content group from the second user; and
storing at least some of the past conversation history in the content group in response to the request of the second user.

18. A method for generating a personalized response, the method being performed by a computing system, comprising:
obtaining a question from a terminal of a first user, the question being for the first user to obtain a response from a second user;
determining a content group corresponding to content access authority of the first user; and
automatically generating a response to the obtained question using one or more contents included in the determined content group.

19. An apparatus for generating a personalized response, comprising:
one or more processors;
a memory loading a computer program executed by the one or more processors; and
a storage storing the computer program,
wherein the computer program includes:
instructions for obtaining a question from a terminal of a first user, the question being for the first user to obtain a response from a second user through a communication platform;
instructions for retrieving related information of the obtained question using a vector database of a content previously registered by the second user;
instructions for automatically generating an augmented prompt for generating a response to the question using an LLM, the augmented prompt including the related information of the question and the obtained question;
instructions for transmitting the automatically generated augmented prompt to the LLM;
instructions for receiving a response to the question from the LLM as a response to the transmission of the augmented prompt; and
instructions for transmitting the response to the question received from the LLM to the terminal of the first user through the communication platform as a response of the second user.

20. An apparatus for generating a personalized response, comprising:
one or more processors;
a memory loading a computer program executed by the one or more processors; and
a storage storing the computer program,
wherein the computer program includes:
instructions for obtaining a question from a terminal of a first user, the question being for the first user to obtain a response from a second user;
instructions for obtaining a relationship between the first user and the second user;
instructions for determining a content group corresponding to the obtained relationship between the first user and the second user; and
instructions for automatically generating a response to the obtained question using one or more contents included in the determined content group.
